(19) United States
(12) Patent Application Publication
(10) Pub. No.: US 2012/0287617 A1
(43) Pub. Date: Nov. 15, 2012

(54) Hybrid grow light

(75) Inventor: George Mekhtarian, Hermosa Beach, CA (US)

(73) Assignee: Modern WoodWorks, Inc.

(21) Appl. No.: 13/068,310

(22) Filed: May 9, 2011

(51) Int. Cl. F21S 10/02

(52) U.S. Cl. 362/228; 362/231

(57) ABSTRACT

A light system for growing plants indoors comprising three light sources each having a different range of wavelengths, power being applied to each light source at an intensity, combination and sequence determined by the growing properties of the plants.

### BACKGROUND OF THE INVENTION

1. Field of the Invention

The present invention provides a light source assembly utilized in the field of indoor horticulture lighting, the light source assembly comprising at least three separate light sources each emitting light of a different frequency.

2. Description of the Prior Art

High intensity discharge (“HID”) lights have been used in indoor horticulture for many years. Specifically, there are two types of HID lights used for indoor growing: metal halide (MH) and high pressure sodium (HPS) based systems. MH lights have a blue tinge and are typically used during vegetative growth. HPS lights emit a yellowish/red tint and are used for the flowering portion of the grow process.

The field of light emitting diodes (LED) is a rapidly advancing technology that has the promise to significantly reduce power consumption for general lighting as well as for indoor horticulture. Over the last five years, ever brighter and more efficient LED emitters in the 3 to 5 W range have been developed; a significant improvement over the LEDs of 10 years ago that did not exceed 50 mW. When used for indoor growing, LED based lights have the advantage of being higher efficiency than other lights. In addition, LEDs can be focused on the photo-synthetically active regions of the light spectrum, namely blue and red (400-500 nm and 600-700 nm, respectively) without wasting energy on the green (500-600 nm) region which is not absorbed well by plants. LEDs emit light in a uni-directional fashion, eliminating the need for reflectors, further improving efficiency. Finally, LEDs have a lifetime of over 50,000 hours compared to less than 10,000 for HID systems, which reduces their overall cost of operation.

As LED based grow light fixtures appeared on the market, the feedback from the indoor growing community has been that LEDs, when used exclusively, do not deliver high plant yields. Using the ratio of final plant or product weight (in grams) over power inputs (in Watts) as a metric measure (g/W), LED based grow lights deliver only marginally better g/W than HID based lights. Given that LED based lights cost five times more than HID based systems (in terms of equivalent total system watts), there is little incentive for growers to use LEDs exclusively.

Another new emerging light technology is the plasma lamp. Plasma lamps are a type of electrodeless lamp energized by radio frequency (RF) power. The first practical plasma lamps were the sulfur lamps but they did not prosper commercially because they suffered a number of problems such as a limited life, large size and high heat. These problems have gradually been overcome by high-efficiency plasma (HEP) lamps that have been introduced to the general lighting market. Modern plasma lamps use a noble gas or a mixture of these gases and additional materials such as metal halides, sodium, mercury or sulfur. The plasma lamps of today deliver high system efficiencies of 90 lumens per watt or more. The advantages of plasma lamps are similar to those of LEDs and include high efficiency, unidirectional light source and long life. Another major advantage of plasma lamps is that light is emitted in a relatively uniform fashion across a broad spectrum (400-700 nm) more closely resembling radiation from the sun.

Tests using plasma lamps for indoor growing have shown positive results. Just as with LEDs, however, the yield in terms of g/W is only marginally better than HID lamps. Given the high cost of plasma based grow light sources (six times or more compared to HID), the return on investment is not justified.

What is desired is to provide a horticulture grow light that overcomes the disadvantages of current systems as noted hereinabove.

### SUMMARY OF THE INVENTION

Empirical data has shown that using a combination of LED, HID and fluorescent (i.e. gas discharge tube) light sources can deliver significant power savings and higher quality plants. LEDs, when used solely during the plant vegetative phase, can reduce power consumption by 70% over HID systems. During the plant flowering phase, LEDs are supplemented either by HID, or plasma lamps (lower power HID units). And in the final phases of plant growth, fluorescent tubes focused in the ultra-violet (UVB-290 to 320 nm) band may be utilized to deliver further benefits for certain types of plants (studies have shown that, for example, lettuce exposed to UVB during growth contains a higher level of healthy antioxidants).

This combination of LED, HID and fluorescent tube light sources or LED, plasma and fluorescent tube lamp light sources have been empirically shown to deliver 40-50% power savings over pure HID lights alone. LED and HID plasma light sources, when utilized for indoor horticulture, can be dimmed to allow further flexibility in growing plants. An example of the costs/power associated with various grow light source systems is as follows:
1. A system with 1,000 W HID light (Cost˜$400).
2. A system with 800 W LED (Cost˜$3,000).
3. A system with 700 W of plasma based light (Cost˜$3600).
4. A system with 200 W LED, 250 W HID, 40 W T8 fluorescent (Cost˜$1000).

5. A system with 200 W LED, 225 W plasma and 40 W T8 fluorescent (Cost˜$1,200).

Empirical data has also shown that the five systems noted hereinabove deliver approximately the same g/W yield. Even though systems #2 and #3 deliver a 20-30% savings in power over system #1, the return on investment (ROI) is poor given the high initial cost of the system. Systems #4 and #5, on the other hand, can deliver over 50% power savings (especially since only LEDs are on during the vegetative phase) and the cost of the system is lower making the ROI much higher.

The present invention thus provides an indoor horticulture light system that consists of 3 types of light sources: LED, HID and fluorescent or LED, plasma and fluorescent that provides significant cost and plant growth advantages over the systems currently available.

### DESCRIPTION OF THE DRAWINGS

For a better understanding of the present invention as well as other objects and further features thereof, reference is made to the following description which is to be read in conjunction with the accompanying drawing therein:

FIG. 1 is a bottom view of the device of the grow light system of the present invention;

FIG. 2 is a top view of the system shown in FIG. 1 having a cover;

FIG. 3 is similar to FIG. 2 with the cover removed;

FIG. 4 is a side view of the present invention with the cover removed;

FIG. 5 illustrates the light coverage areas of three different light sources;

FIG. 6 is a block diagram illustrating the electrical connections used in the light system of the present invention;

FIG. 7 is a block diagram of the plasma light source;

FIGS. 8(a)-8(d) are perspective views of the plasma embodiment; and

FIGS. 9(a)-9(d) are perspective views of the HID embodiment (high pressure sodium lamp version).

### DESCRIPTION OF THE INVENTION

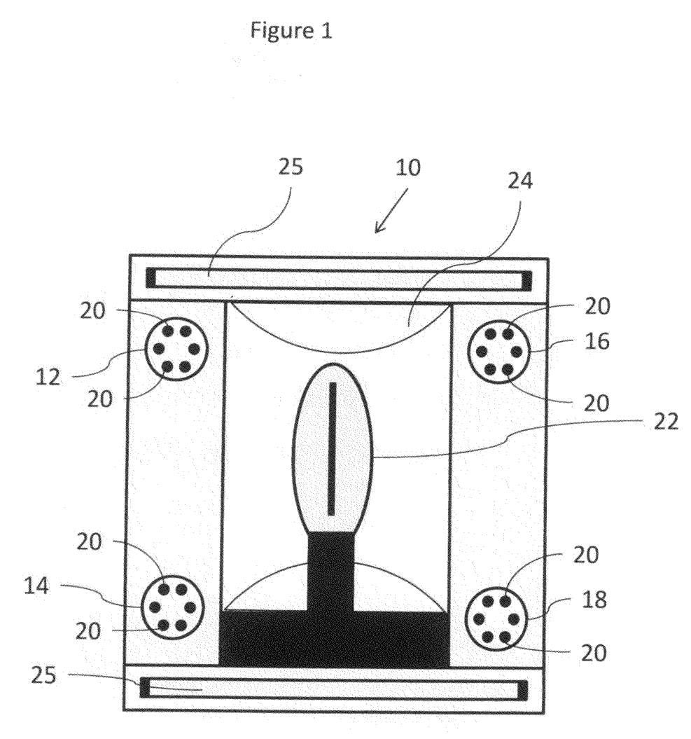

FIG. 1 is a bottom view of the light system 10 of the present invention and shows four LED light sources 12, 14, 16 and 18 that each consist of a plurality of LED emitters 20 (six shown in the figure) in various color combinations to optimize plant photosynthesis. The LED light sources are LEDs mounted on a printed circuit board (either metal core PCB or standard FR4 PCB) and mated to a heat sink since good thermal management is essential to the performance and lifetime of the LED emitters. Recently developed LED light sources can be made with larger footprints and encapsulate twelve or more LED emitters of different peak wavelengths (colors) in a single package.

In addition to the four LED light sources noted hereinabove, light system 10 includes an HID light source 22 at the center light system 10 as shown in FIG. 1. The HID light source can either be MH or BPS based systems designed with a ballast that can accommodate either type of light source (the HID light source requires a reflector 24, the reflector design being standard in the industry). Alternatively, the HID light and reflector can be replaced by a plasma light source which consists of a plasma bulb encased in a special RF waveguide.

Fluorescent T8 type types 25 and 26 tubes are also incorporated into system 10. The most useful type of fluorescent light tubes are ultra-violet (UVBB-290 to 320 nm), certain plants benefiting from light in this wavelength band.

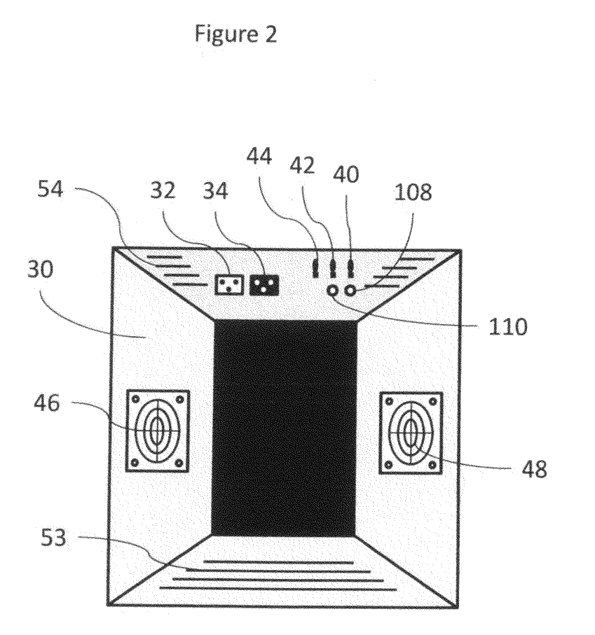

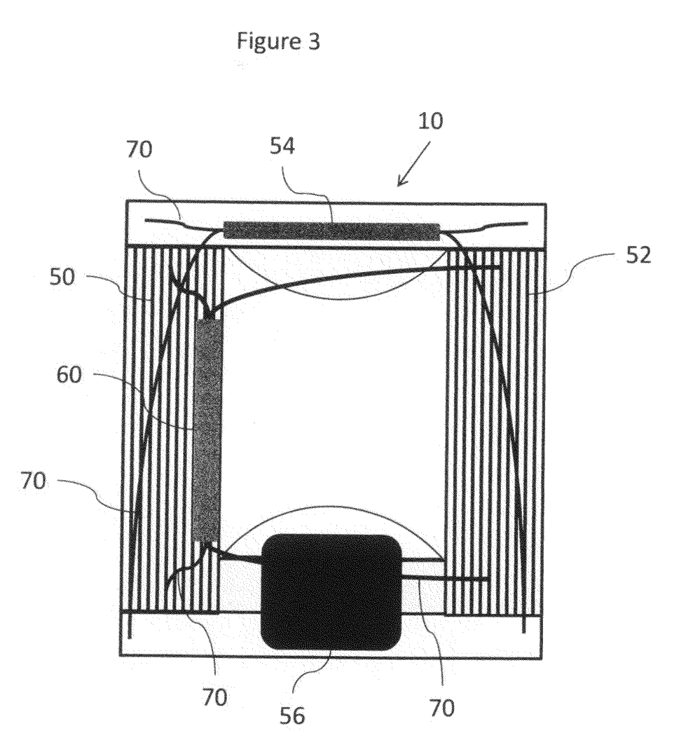

FIG. 2 is a top view of system 10 illustrating the top portion 30 of cover 31. Two power plugs (male and female) 32 and 34 are incorporated into the system to allow daisy chaining (daisy chaining provides a means for connecting multiple units to one another in a chain so that a single power outlet and single timer can be used. This requires that each unit have two types of power plugs (male and female) so that each unit can power the unit down the chain). Three on/off buttons 40, 42 and 44 control the power furnished to each of the three types of light types and are preferably operated manually by a user. In addition, two dimming controls 108 and 110 control the power level applied to the LED and the HID or plasma lights and thus the intensity of the emissions produced thereby. Two cooling fans 46 and 48 provide active air flow over the LED heat sinks 50 and 52 (see FIG. 3) to keep the temperature of the LEDs within an acceptable range. Cooling vents 53 and 54 on the sides control the air flow through system 10.

FIG. 3 illustrates light system 10 with cover 31 removed and shows LED heat sinks 50 and 52 positioned adjacent the sides of system 10. Current limiting ballasts 55 and 56 are provided for the HID and fluorescent lights and LED power supply and driver circuit 60 (the LED power supply and driver circuit converts 120 VAC to a DC current controlled power for LED use since LEDs need a constant current source to operate properly. At a fixed voltage, current through the LED can vary significantly with temperature. Therefore a constant voltage applied to a LED string can cause the LEDs to exceed their maximum current rating and fail. Thus, in order to properly operate the LEDs, a power supply and a constant driver circuit are necessary). The HID ballast 55 is replaced with the plasma power supply and RF generation system when a plasma emitter is used instead of the HID light source. Wiring 70 illustrates in simplified form the connections between components.

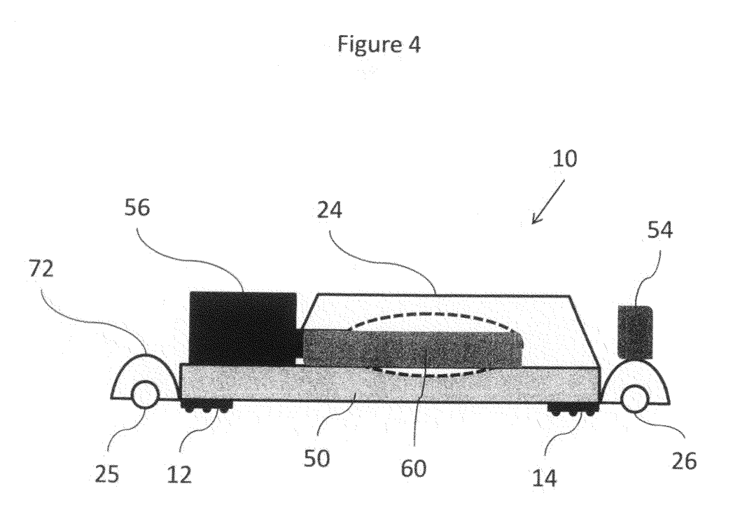

FIG. 4 is a side view of light system 10 with cover 31 removed and shows the HID ballast 54, fluorescent tubes 25 and 26, LED heat sink 50, HID reflector 24, fluorescent tube reflectors 72, fluorescent ballast 56, LED power supply and driver circuit 60 and LED light sources 12 and 14. A plasma power supply and RF generator system replaces the HID ballast 54 when a plasma emitter is used instead of the HID light source.

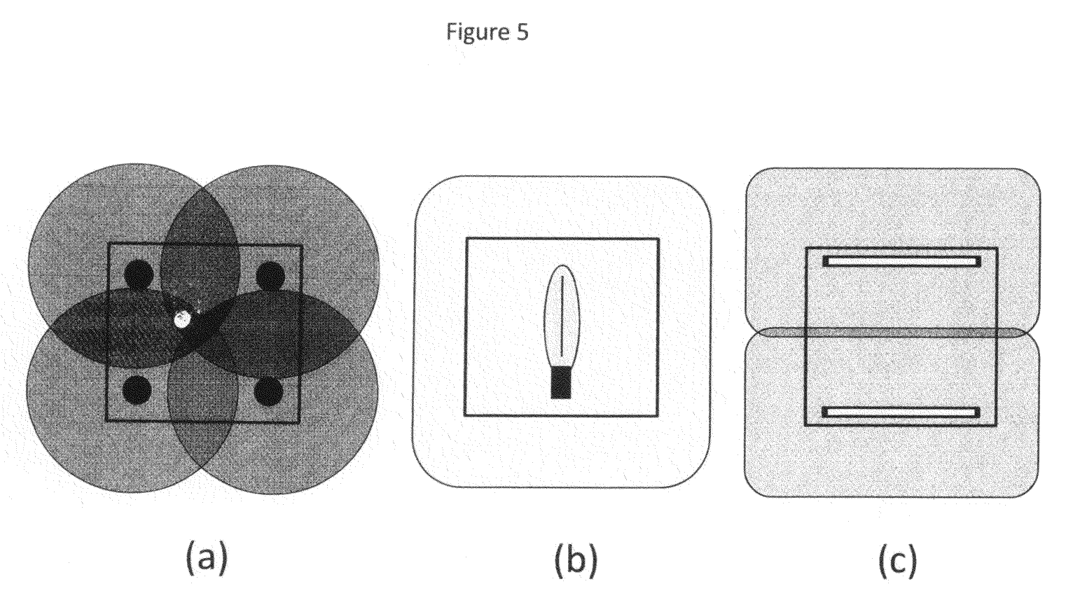

FIG. 5 illustrates the light coverage areas provided by each light type. It is essential that, for any given height, system 10 delivers approximately the same light coverage footprint from each type of light. In this figure, the relative light coverage area is shown for a (a) LED, (b) HID or plasma and (c) fluorescent tube. For a LED, the coverage area is dictated by the design of the primary and secondary (if necessary) optics. For the HID, plasma and fluorescent tube lights, their respective reflector designs dictate the coverage area. It is desirable to maintain overlapping coverage area footprints for all three light types.

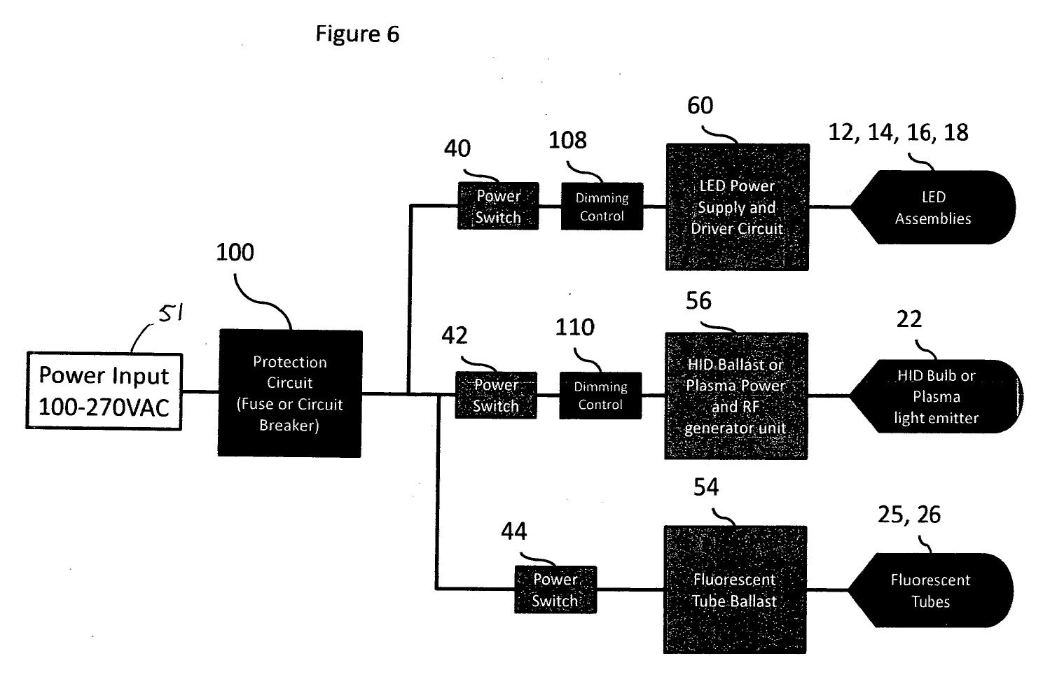

FIG. 6 illustrates the electric block diagram for light system 10 using an AC power input (100-270 VAC) 51. Protection circuit 100 (a fuse or circuit breaker) couples power input 51 such that switches 40, 42 and 44, and diming control circuits 108, 110 are supplied with power. HID ballast or plasma power and RF generator unit 56, fluorescent tube ballast 54, and LED power supply and driver circuit 60 are coupled to their respective light emitters. In particular, LED power supply and driver circuit 60 is coupled to LED assemblies 12, 14, 16 and 18 to power those units on or off; HID ballast or plasma power and RF generator unit 56 is coupled to HID bulb or plasma light source 22 and fluorescent tube ballast 54 drives fluorescent tubes 25 and 26.

The combination of the three types of lights reduces the cost of grow lights. One theory as to why LEDs on their own cannot deliver good yield is that during the flowering phase when plant mass increases, a significant amount of light (photon energy) is needed to help drive carbohydrate formation. This type of light intensity is not necessary during vegetative growth. Building a light that can deliver significant photon energy for flowering using LEDs will be very expensive. HID lights are a much cheaper and relatively efficient alternative to delivering photon energy even though it is not concentrated in the red and blue regions of the light spectrum where absorption by plants is highest.

When system 10 is ready for use, power input 51 applies power to system 10. The user then determines when the different light sources are to be energized and for what time period; buttons 40, 42 and 44 are then manually depressed in a predetermined sequence. Similarly, the user determines which of the dimming controls 108 and 110 should be operative and proceeds to operate the diming controls accordingly.

Light system 10 is manually operable in order to reduce system costs, although, the operation can be microprocessor controlled to provide a faster system.

Although energization of each of the light source types is preferably done in a predetermined sequence, circumstances may dictate that at least two of the light types are energized at the same time.

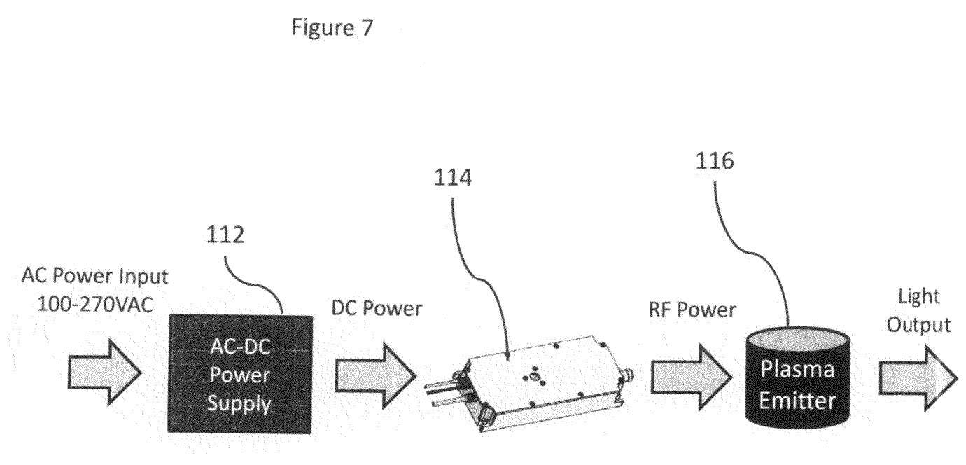

FIG. 7 is a block diagram of the plasma light source 120. As previously explained, the plasma light source can be used in lieu of the HID light source in system 10. The plasma light source delivers light across a wider spectrum than an HID light source and comprises a AC-DC power supply 112 which converts an AC power input to a constant voltage DC power (typically 28 VDC.) The output of power supply 112 energizes RF driver 114 which in turns generates RF power (in the GHz range) to excite a plasma and generate light in the plasma light source/emitter 116.

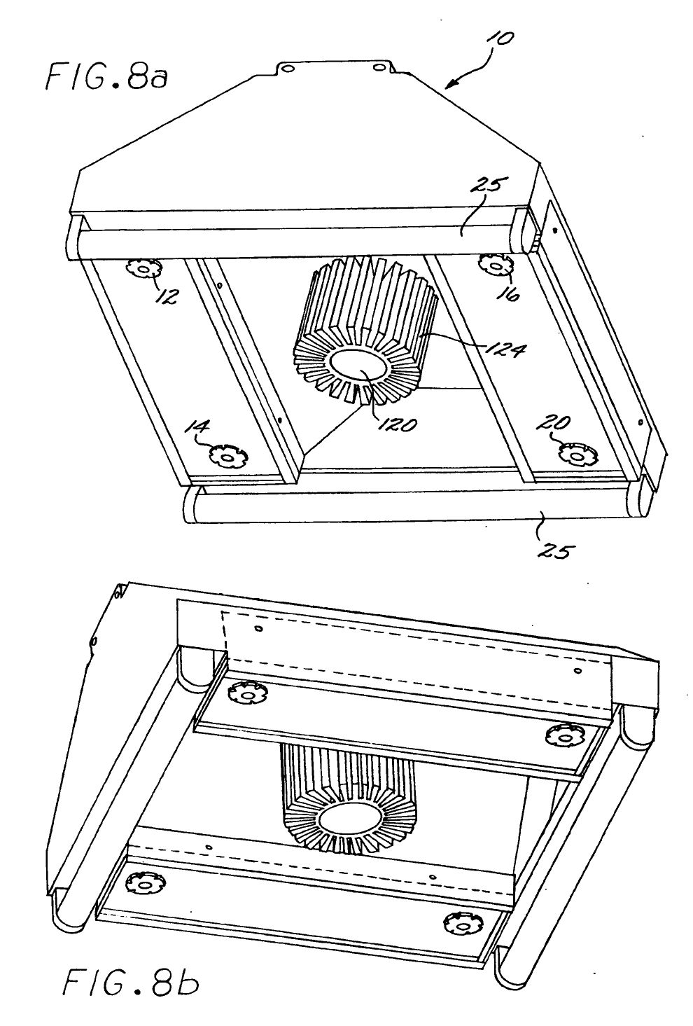

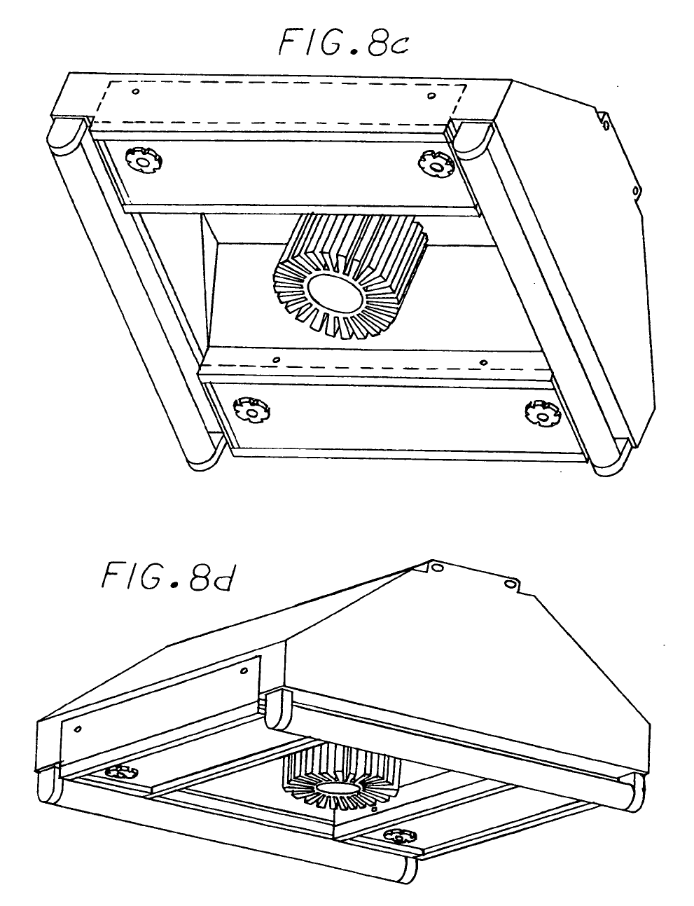

FIGS. 8(a)-8(d) illustrate various perspective views of light system device 10 wherein a plasma light source 120 is utilized along with fluorescent tubes 25 and 26 and LED emitters 12, 14, 16 and 18. Metal cooling fins 124 surround light source 120 as illustrated. The power supply and RF driver (not shown) are positioned within the housing adjacent light source 120.

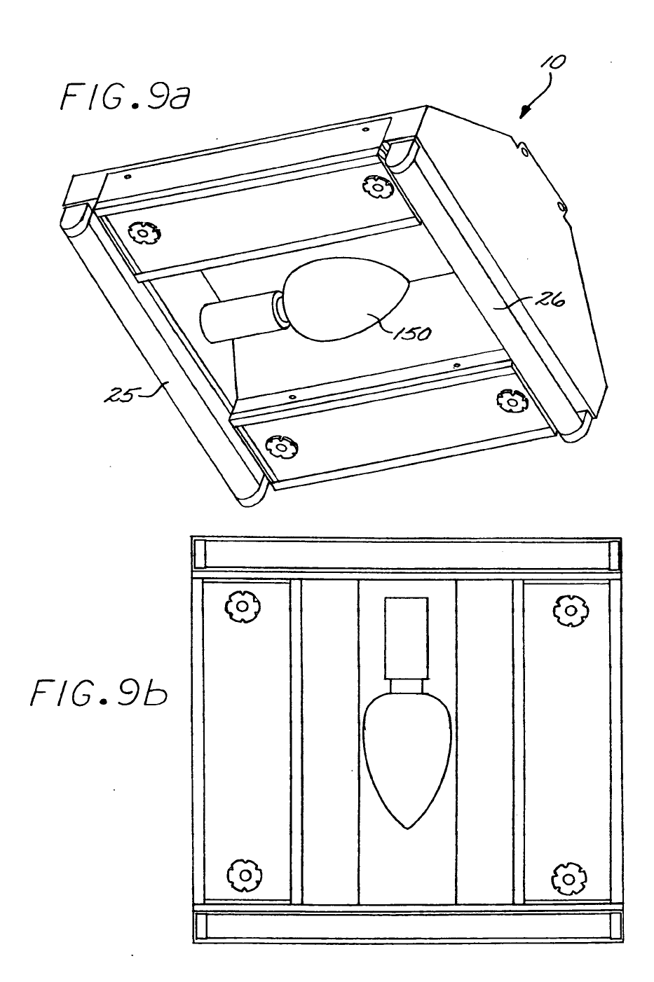

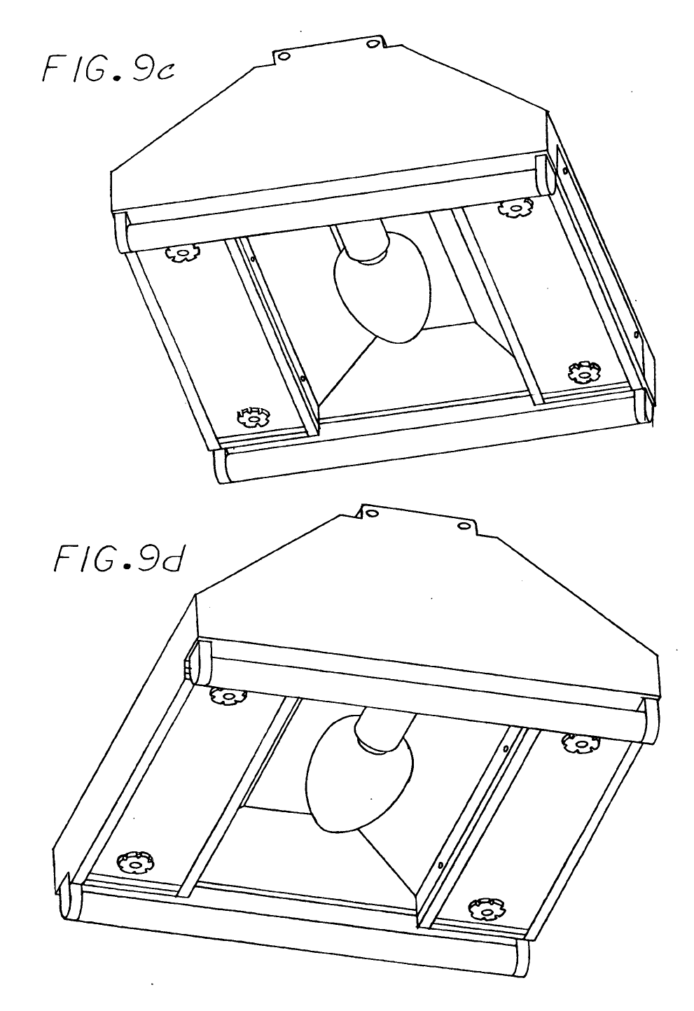

FIGS. 9(a)-9(d) show various perspective views of light system 10 wherein a BPS source 150 is utilized in place of the plasma source 120 shown in FIGS. 8(a)-8(b). In addition to the HPS, the light system includes fluorescent tubes 25 and 26 and LED emitters 12, 14, 16 and 18.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A light system for use in growing plants indoors comprising:
a housing;
a first illumination source for generating a first group of wavelength ranges;
a second illumination source for generating a second group of wavelength ranges that are different from said first group;
a third illumination source for generating a third group of wavelength ranges that are different from said first and second group; said first, second and third source of illumination being mounted within said housing;
means for energizing said first, second and third illumination sources in a combination and sequence determined by the properties of said plants.

2. The system of claim 1 whether said first illumination source comprises LEDs.

3. The system of claim 2 wherein said second illumination source comprises at least one fluorescent bulb.

4. The system of claim 3 wherein said third illumination source comprises a HID bulb.

5. The system of claim 3 wherein said third illumination source comprises a plasma tube.
